(19) United States
(12) Patent Application Publication
(10) Pub. No.: US 2010/0278388 A1
(43) Pub. Date: Nov. 4, 2010

(54) SYSTEM AND METHOD FOR GENERATING A DYNAMIC BACKGROUND

(75) Inventors: Chia-Chun Tsou, Taipei County (TW); Chih-Heng Fang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UTECHZONE CO., LTD., Taipei County (TW)

(21) Appl. No.: 12/725,612

(22) Filed: Mar. 17, 2010

(30) Foreign Application Priority Data
Apr. 29, 2009 (TW) 98114205

(51) Int. Cl. G06K 9/00

(52) U.S. Cl. 382/103; 382/104

(57) ABSTRACT

A system and methodology that counts a number of moving objects including the pedestrians within predetermined areas. According to certain embodiments, a system comprises an image sensing device and a data processing device. The image sensing device is situated at a predetermined area. The image sensing device retrieves a series of images of the moving objects within the predetermined area. The data processing device is coupled to the image sensing device. The data processing device processes the retrieved image to generate a dynamic background of the first predetermined area and determine a flow of the moving objects thereon.

### BACKGROUND OF THE INVENTION

1. Field of the Invention

The present invention relates generally to a system and method for generating a dynamic background, and more particularly to a system and method for generating a dynamic background in a system for analyzing number of people, speed of pedestrians and the direction thereof.

2. Description of Prior Art

Conventional inductive loop vehicle detectors provide information about vehicles in an area of the roadway. The inductive loop detector is a low cost and well known technology, but it typically can only monitor a small area. In practice, a loop is embedded in a lane of a roadway, and the loop magnetically senses when a large mass of metal passes over it. By placing two loops a known distance apart, the speed of a vehicle across the two loops can be measured with limited accuracy. Loops therefore provide vehicle count and speed at a specific point in each lane to the traffic manager. Multiple traffic lanes require multiple sets of loops (typically one loop per traffic lane).

Current techniques available in the conventional inductive loop detector provide no notion of how to solve the problem of analyzing a number of pedestrians, not to mention the result of analyzing a speed of pedestrians and their corresponding direction of movement.

### SUMMARY OF THE INVENTION

Embodiments of the present invention provide an analyzing system and generating system thereof to resolve the foregoing problems faced by the conventional inductive loop detector. Embodiments of the present invention also enjoy the advantage of providing information concerning speed of pedestrians and their relative direction of movement.

An object of the present invention is to provide an analyzing system and generating system thereof, wherein detailed information on number, speed and direction of moving objects is detected and stored.

In accordance with an aspect of the present invention, a system for analyzing pedestrian flow comprises an image collecting unit, a storing unit and a determining unit. The image collecting unit is situated at a first predetermined location for collecting an image of the first predetermined location. The storing unit is used for storing image collected by the image collecting unit. The determining unit is used for determining pedestrian flow in the first predetermined location. The determining unit has a generating module and a discriminating module. The generating module is used for generating a background of the first predetermined location. The discriminating module is used for discriminating the pedestrian flow in the first predetermined location. The generating module records first image to n-th image collected by the image collecting unit at time point t1 until time point to respectively, and chooses one most frequently appeared image of the n images. The most frequently appeared image is determined as the background of the first predetermined location.

In embodiments of the invention, the image collecting unit may be waterproof, wireless, and may comprise a CCD (Charge Coupled Device) camera. In embodiments of the invention, the first predetermined location is an intersection. In certain embodiments, the determining unit is situated at the first predetermined location, and the storing unit is situated at the first predetermined location. In other embodiments, the determining unit is situated at a second predetermined location, and the storing unit is situated at the second predetermined location as well. In yet other embodiments, the storing unit is situated at a third predetermined location.

In accordance with another aspect of the present invention, a system for generating a dynamic background of a first predetermined location is suitable for an analyzing system. The analyzing system provides a time point t1 until a time point tn. The system for generating a dynamic background comprises a recording unit and an analyzing unit. The recording unit is used for recording a first image to an n-th image at a time point t1 until a time point tn respectively. The analyzing unit is used for analyzing every pixel in the n images. The most frequently appeared imagemost frequently appeared image value is determined as background value of the pixel. The background value of each pixel is then integrated into the dynamic background of the first predetermined location.

In embodiments of the invention, the analyzing system retrieves the first image to the n-th image at the time point t1 until the time point tn respectively. Each time interval between the n consecutive time points is the same. The dynamic background of the first predetermined location is transmitted to the analyzing system. The analyzing system analyzes data of the n images.

In accordance with a third aspect of the present invention, a method for generating a dynamic background of a first predetermined location comprises the steps of: providing a time point t1 until a time point tn, where n is a positive integer; recording a first image to an n-th image at the time point t1 until the time point tn respectively; and analyzing every pixel in the n images, the most frequently appeared image value being determined as background value of the pixel, the background value of each pixel is then integrated into the dynamic background of the first predetermined location.

In embodiments of the invention, the method further comprises the step of retrieving the first image to the n-th image by the analyzing system at the time point t1 until the time point tn respectively. Each time interval between the n consecutive time points is the same.

The present invention may best be understood through the following description with reference to the accompanying drawings, in which:

### BRIEF DESCRIPTION OF THE DRAWINGS

FIG. 1 shows a schematic block diagram of an analyzing system of an embodiment according to the present invention.

FIG. 2 shows a schematic flow chart of an analyzing system of another embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

Embodiments of the present invention embody a new analyzing system to detect a number, speed, and direction of moving objects. Accordingly, the information can be stored and add value in analyzing pedestrian flow at a predetermined location or area.

According to one embodiment of the present invention, an analyzing system for analyzing pedestrian flow comprises an image collecting unit, a storing unit and a determining unit. The image collecting unit is situated at a first predetermined location for collecting an image of the first predetermined location. The storing unit is used for storing image collected by the image collecting unit. The determining unit is used for determining pedestrian flow in the first predetermined location. The determining unit has a generating module and a discriminating module. The generating module is used for generating a background of the first predetermined location. The discriminating module is used for discriminating the pedestrian flow in the first predetermined location. The generating module records first image to n-th image collected by the image collecting unit at time point t1 until time point to respectively, and chooses one most frequently appeared image of the n images. The most frequently appeared image is determined as the background of the first predetermined location.

In certain embodiments, the image collecting unit may be waterproof, wireless, and may comprise a CCD (Charge Coupled Device) camera. Such embodiments are well suited for being situated outdoors, and for the ready communication of information, without requiring hard-wiring of the device components. The image collecting unit is situated at the first predetermined location. In one embodiment, the first predetermined location is at least an intersection and the image collecting unit is configured to count pedestrians.

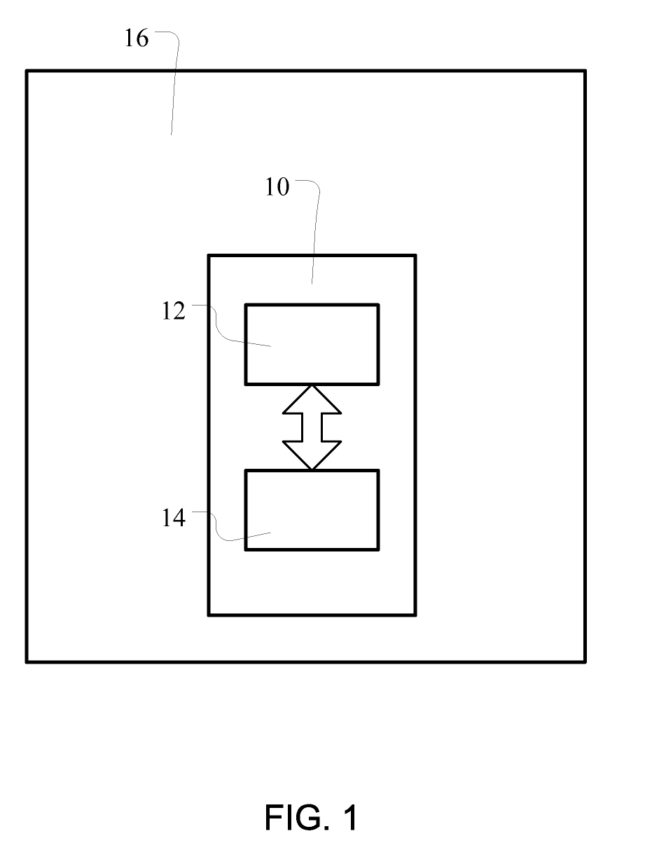

Referring to FIG. 1, a schematic block diagram of an analyzing system of a preferred embodiment according to a preferred embodiment of the present invention is shown. A system 10 for generating a dynamic background of a first predetermined location is suitable for the analyzing system 16. The analyzing system 16 provides a time point t1 until a time point tn. The system 10 for generating a dynamic background comprises a recording unit 12 and an analyzing unit 14. The analyzing system 16 may comprise at least a CCD (Charge Coupled Device) camera. The CCD camera may be waterproof and wireless. The analyzing system 16 retrieves the first image to the n-th image at the time point t1 until the time point tn respectively. Each time interval between the n consecutive time points is the same.

The recording unit 12 is used for recording a first image to an n-th image at a time point t1 until a time point tn respectively. The moving objects, such as pedestrians, and background of the first predetermined location at every time point are recorded in the n images. The analyzing unit 14 is used for analyzing every pixel in the n images. The most frequently appeared image value is determined as background value of the pixel. The background value of each pixel is then integrated into the dynamic background of the first predetermined location. The dynamic background of the first predetermined location is transmitted to the analyzing system 16. The analyzing system 16 may analyze data of the n images for further added value processing. Hence, flow of the moving objects on the images could be determined.

According to another embodiment of the present invention, a system for analyzing pedestrian flow comprises an image collecting unit, a storing unit and a determining unit. The image collecting unit is situated at a first predetermined location for collecting an image of the first predetermined location. The storing unit is used for storing image collected by the image collecting unit. The determining unit is used for determining pedestrian flow in the first predetermined location. The determining unit has a generating module and a discriminating module. The generating module is used for generating a background of the first predetermined location. The discriminating module is used for discriminating the pedestrian flow in the first predetermined location. The generating module records first image to n-th image collected by the image collecting unit at time point t1 until time point to respectively, and chooses one most frequently appeared image of the n images. The most frequently appeared image is determined as the background of the first predetermined location.

In embodiments of the invention, the image collecting unit may be waterproof, wireless, and may comprise a CCD (Charge Coupled Device) camera. In one embodiment, the first predetermined location is an intersection, and the determining unit is situated at the first predetermined location. In another embodiment, the determining unit is situated at a second predetermined location. Similarly, in various embodiments, the storing unit may be situated at either the first predetermined location, the second predetermined location, or the third predetermined location.

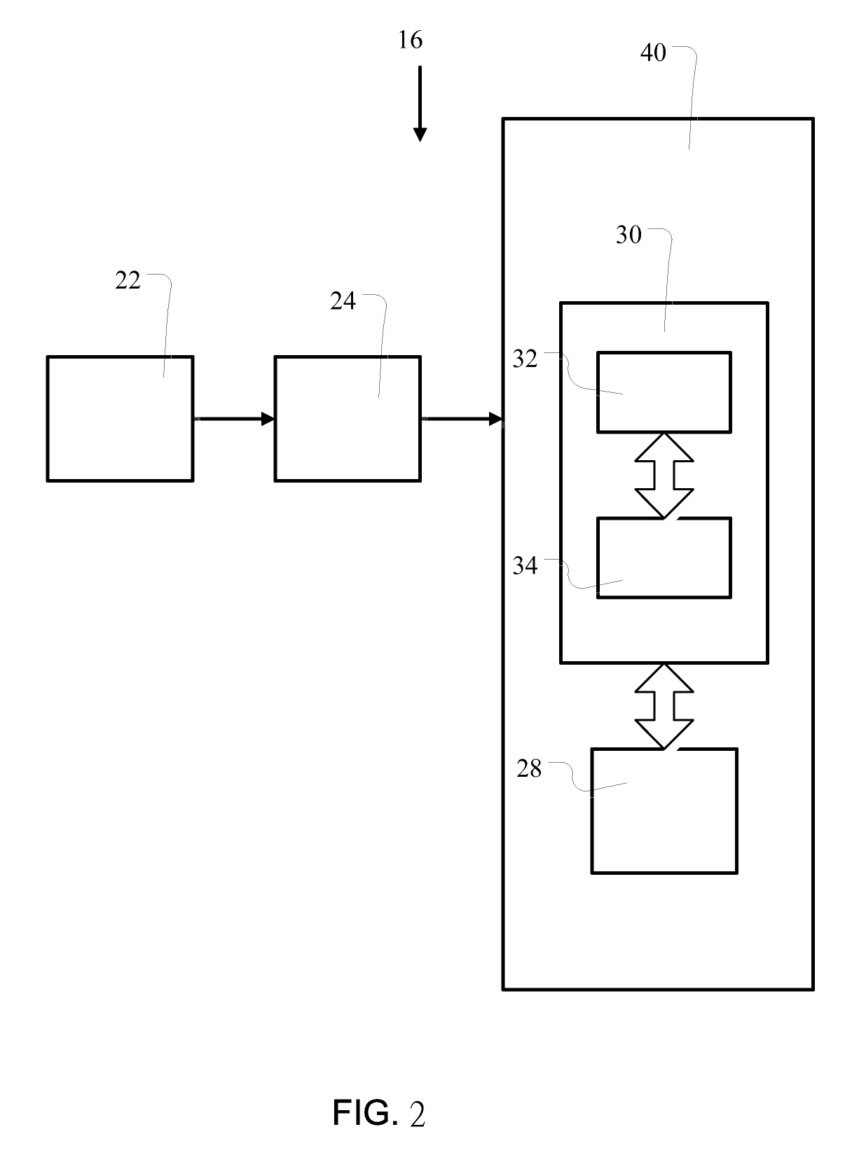

Referring to FIG. 2, a schematic block diagram of a counting system of another embodiment, according to the present invention, is shown. The analyzing system 16 for analyzing pedestrian flow of this embodiment is adapted for counting the number of moving objects, which comprises an image collecting unit 22, a storing unit 24 and a determining unit 40.

The image collecting unit 22 is situated at a first predetermined location for collecting image of the first predetermined location. The first predetermined location is at least an intersection. The image collecting unit 22 may be waterproof. The image collecting unit 22 may be wireless. The image collecting unit 22 may be at least a CCD (Charge Coupled Device) camera.

The storing unit 24 is coupled to the image collecting unit 22. The storing unit 24 is used for storing image collected by the image collecting unit 22. The determining unit 40 is used for determining pedestrian flow in the first predetermined location, wherein the determining unit 40 has a generating module 30 and a discriminating module 28.

The generating module 30 is used for generating a dynamic background of the predetermined location. The discriminating module 28 is used for discriminating the pedestrian flow in the first predetermined location. The generating module 30 records first image to n-th image collected by the image collecting unit at time point t1 until time point to respectively, and chooses one most frequently appeared image of the n images. The most frequently appeared image is determined as the background of the first predetermined location.

The determining unit 40 may be situated at the first predetermined location. Alternatively, the determining unit 40 may be situated at a second predetermined location. The storing unit 24 may be situated at the first predetermined location. Alternatively, the storing unit 24 may be situated at the second predetermined location, along with the determining unit 40. Also, the storing unit may be situated at a third predetermined location separately.

For the sake of cost-savings and efficiency, one may equip the image collecting unit 22 only at the intersection, while the retrieved image is remotely transmitted to the storing unit 24 and the determining unit for further added value processing.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system for generating a dynamic background of a first predetermined location, suitable for an analyzing system operating from a time point t1 until a time point tn, said system for generating a dynamic background comprising:
a recording unit for recording a first image to an n-th image at the time point t1 until the time point tn respectively; and
an analyzing unit for analyzing every pixel in said n images, the most frequently appeared image value being determined as background value of said pixel, said background value of each pixel being then integrated into said dynamic background of said first predetermined location.

2. The system according to claim 1, wherein said analyzing system retrieves said first image to said n-th image at said time point t1 until said time point tn respectively.

3. The system according to claim 1, wherein each time interval between n consecutive time points is the same.

4. The system according to claim 1, wherein said dynamic background of said first predetermined location is transmitted to said analyzing system, and said analyzing system analyzes data of said n images.

5. A method for generating a dynamic background of a first predetermined location comprising the steps of:
providing a time point t1 until a time point tn, where n is a positive integer;
recording a first image to an n-th image at said time point t1 until said time point tn respectively; and
analyzing every pixel in said n images, the most frequently appeared image value being determined as background value of said pixel, said background value of each pixel being then integrated into said dynamic background of said first predetermined location.

6. The method according to claim 5, further comprising the step of retrieving said first image to said n-th image by an analyzing system at said time point t1 until said time point tn respectively.

7. The method according to claim 5, wherein each time interval between n consecutive time points is the same.

8. A system for analyzing pedestrian flow comprising:
an image collecting unit situated at a first predetermined location for collecting an image of said first predetermined location;
a storing unit for storing the image collected by said image collecting unit; and
a determining unit for determining the pedestrian flow in said first predetermined location, said determining unit has a generating module for generating a background of said first predetermined location and a discriminating module for discriminating said pedestrian flow in said first predetermined location, wherein said generating module records first image to n-th image collected by said image collecting unit at time point t1 until time point to respectively, and chooses one most frequently appeared image of said n images, the most frequently appeared image being determined as said background of said first predetermined location.

9. The system according to claim 8, wherein said first predetermined location is an intersection.

10. The system according to claim 8, wherein said determining unit is situated at said first predetermined location.

11. The system according to claim 8, wherein said determining unit is situated at a second predetermined location.

12. The system according to claim 8, wherein said storing unit is situated at said first predetermined location.

13. The system according to claim 8, wherein said storing unit is situated at a second predetermined location.

14. The system according to claim 8, wherein said storing unit is situated at a third predetermined location.

15. The system according to claim 8, wherein said image collecting unit is waterproof.

16. The system according to claim 8, wherein said image collecting unit is wireless.

17. The system according to claim 8, wherein said image collecting unit is a CCD (Charge Coupled Device) camera.
